(19) United States
(12) Patent Application Publication
(10) Pub. No.: US 2019/0084036 A1
(43) Pub. Date: Mar. 21, 2019

(54) METHOD FOR PRODUCING A CAST METAL PART, IN PARTICULAR A HOUSING OF AN ELECTRIC MOTOR STATOR, A HOUSING FOR COMPONENTS OF POWER ELECTRONICS, A BATTERY TRAY OR A BATTERY HOUSING, CAST PART PRODUCED USING THE METHOD, AND USE OF A COOLING CHANNEL PRODUCED BY ROLL WELDING

(71) Applicant: AIONACAST CONSULTING GMBH, Vaihingen an der Enz (DE)

(72) Inventor: Jürgen POHL, Vaihingen an der Enz (DE)

(21) Appl. No.: 16/083,289

(22) PCT Filed: Mar. 7, 2017
(86) PCT No.: PCT/EP2017/000304

§ 371 Date: Sep. 7, 2018

(30) Foreign Application Priority Data
Mar. 7, 2016 (DE) 10 2016 002 791.6

(51) Int. Cl. B22D 19/00; B22D 19/04; B23K 20/04

(52) U.S. Cl. CPC B22D 19/0072; B22D 19/0054; B23K 20/04; B22D 19/0081; B22D 19/04

(57) ABSTRACT

The invention relates to a method for producing a cast metal part, in particular a housing of an electric motor stator, a housing for components of power electronics, and a battery tray or a battery housing, having the following steps: producing a cooling channel, introducing the cooling channel into a casting tool, filling the casting tool with a casting material, and molding the cast part. According to the invention, the production of the cooling channel includes a roll welding step.

### CROSS REFERENCE TO RELATED APPLICATION

The present application is a 35 U.S.C. § 371 national phase entry application of, and claims priority to, International Patent Application No. PCT/EP2017/000304, filed Mar. 7, 2017, which claims priority to German Patent Application No. DE 102016002791.6, filed Mar. 7, 2016, the disclosures of which are hereby incorporated by reference in their entirety for all purposes.

### BACKGROUND

The invention relates to a method for producing a cast metal part, in particular a housing of an electric motor stator, a housing for components of power electronics, a battery tray or a battery housing, having the following steps: producing a cooling channel, introducing the cooling channel into a casting tool, filling the casting tool with a casting material, and molding the cast part.

Methods of the above type are known. In the known method, the cooling channel to be introduced into the casting tool is produced, for example, by extrusion in the form of a seamless tube. Such a method is very elaborate. Moreover, it is difficult to reshape extruded tubes to follow a path dictated by the shape of the cast part to be produced. Finally, it is not possible by extruding to produce a cooling channel with branches.

In principle, it is also conceivable to produce the cooling channel to be inserted into the casting tool with a welding method in which the corresponding raw material is welded along one or two welds using a filler material. In particular, because of the filler material usually used in this case, there is, however, a different structure or a different chemical composition in the region of the weld than in other regions of the cooling channel, so that when heated during filling of the cast part an undesirable and non-controllable deformation of the cooling channel occurs. In addition, as with the use of extruded tubes as a cooling channel, there is also the problem with the tubes welded as described above that it is not possible or only with considerable effort to produce a cooling channel with branches.

From EP 0 858 692 B1 a method for producing a cast metal part according to the preamble of claim 1 is known. Accordingly, the tubes used as a cooling channel are preferably made of steel or steel alloys. Such tubes have a high rigidity. It is therefore difficult to reshape them so as to follow a path given by the shape of the cast part to be produced. Also, it is difficult or even impossible to produce a cooling channel with branches from such tubes. The tubes have a higher melting point than the casting material and are placed in the mold preheated.

DE 2 227 427 A describes the production of a cooling channel by roll welding, pure aluminum being indicated as the material to be used. The cooling channel thus produced is combined with other similar channels to form a heat exchanger.

### SUMMARY

In view of the above problems, the invention has the object of developing the method of the type mentioned above in such a way that the flexibility in the design of the cooling channel, in particular with regard to, for example, branches is increased and unwanted deformations are avoided. Furthermore, the method should be easy to carry out.

According to the invention, this object is achieved in the method of the type mentioned above in that the production of the cooling channel includes the step of roll welding.

In this case, the invention is based on the finding that roll welding can also be used without problems for branching cooling channels. Furthermore, it works without filler materials, which is why undesirable deformations are avoided, for example due to thermal stress. Finally, it is particularly easy to carry out and the cooling channel produced by means of roll welding requires only few deformation to adapt to the profile predetermined by the shape of the cast part.

Preferably, according to the invention, the method for producing the cooling channel includes the following steps:

a) providing two sheets,
b) applying a release agent in at least a region of the sheets,
c) heating the sheets,
d) roll welding the sheets; and
e) applying pressure such that a channel is formed in the region provided with the release agent,
wherein steps b) and c) can also be performed simultaneously or in reverse order.

According to this embodiment of the invention, the cooling channel is thus initially produced in the form of a planar structure, whereby it is particularly easy to realize any predetermined channel paths, including branches. The release agent may be a graphite release agent.

Preferably, according to the invention, when pressure is applied to form the channel, at least one abutment is arranged such that the outer skin of the channel abuts against it and so assumes a profile corresponding to the abutment.

As a result, the cross section of the channel can be predetermined. With a suitable design of the abutment, the cross section can also change over the length of the channel.

Likewise preferred according to the invention, the step of punching out the stack of sheets is provided. As a result, the amount of sheet metal material to be filled can be reduced or even minimized.

According to the invention it is further preferred that during punching at least one core bearing and/or at least one spacer and/or at least one fastening tab is/are formed.

In other words, this embodiment of the invention makes use of the possibility of producing core bearings, spacers and/or fastening tabs integrally with the cooling channel, which simplifies the overall production process of the cast part.

According to a further preferred embodiment of the invention it is provided that the cooling channel is brought into a predetermined shape, in particular in the shape of a groove, prior to introduction or during introduction into the casting tool.

In other words, according to this embodiment, the structure initially produced in a planar manner is bent to form a groove in order to adapt it to the, for example, groove-shaped form of the cast part to be produced.

The filling of the casting tool according to the invention is preferably carried out in the manner of sand casting or chill casting including all subtypes, such as low pressure chill casting, gravity chill casting, tilting chill casting, etc. Other casting methods may be used, provided that it is ensured that the method used does not adversely affect the cooling channel previously introduced into the casting tool.

Further preferred, according to the invention, it is provided that at least one of the sheets and/or the casting material contain(s) a light metal or a light metal alloy. Examples include aluminum and magnesium and their alloys. For the sheet(s) particularly very soft aluminum come(s) into consideration, e. g., yield stress RP, 0, 2 EN AW-1050A approx. 40 N/mm2; see DIN EN 485-2. The material used for the sheet(s) must be soft enough when pressurized with the aid of gaseous media, so that a channel forming deformation occurs.

According to the invention, it may be advantageous in particular that the melting range of the sheets is higher than that of the casting material. This can avoid, by appropriate setting of the casting temperature that the cooling channel is negatively impacted during casting.

Additionally or alternatively, it may be provided according to the invention that the cooling channel is cooled before and/or during the filling of the casting tool. This also allows to prevent the cooling channel introduced into the casting tool from being damaged due to the high temperature of the casting material during filling of the casting tool.

In addition, cooling channel preheated, for example, at approx. 300° C. to 400° C. can favor the melting of a very thin boundary layer and thus increase the effective contact area.

According to a further preferred embodiment of the invention it is provided that the outer surface of the cooling channel is coated. In this way, an improvement of the boundary layer can be achieved. Applicable methods include, for example, hot dip galvanizing and an electrolytic coating with the base materials zinc, magnesium, manganese and/or titanium zirconium.

Coating may take place prior to or after roll welding on the sheets used for this purpose, but prior to filling the casting tool with casting material.

Furthermore preferred, according to the invention, it can be provided that the casting tool is subjected to ultrasound during the casting process. This measure also serves to improve the boundary layer.

Further, advantageously, according to the invention a heat treatment of the cooling channel may be provided. Said heat treatment is preferably carried out after applying pressure to the two roll-welded sheets to form the cooling channel. The heat treatment can positively influence the tensile strength of the cooling channel. For example, the heat treatment may be carried out at a temperature of 320° C. to 350° C. for 0.5 hour to 2 hours, followed by cooling.

According to a particularly preferred embodiment of the invention, it is provided that at least one surface of at least one of the sheets is roughened prior to filling the casting tool, in particular by using a profiled roll during roll welding or by blasting the sheet(s) with sand or with stainless steel granules. This allows a better mold filling with the casting material.

According to a further preferred embodiment it can be provided that the cooling channel is pressurized internally during the casting process. In this way, any further impairments of the cooling channel during the casting process can be avoided.

Besides the above production method, the invention creates a cast part having a cooling channel. According to the invention, the cast part is produced by the method described above.

In this case, it is preferably provided according to the invention that the cooling channel has an inner cross-section which increases at least in sections over its length.

In this way, when coolant flowing through the cooling channel, a pressure drop can be generated, which extracts energy in the form of heat from the coolant, whereby the cooling effect is increased.

According to the invention, the cooling channel can also have an inner cross-section deviating at least in sections from the circular shape.

As a result, special effects can be achieved in cooling.

For example, it can be provided according to the invention that, at least in sections, the inner dimension of the cooling channel in the thickness direction of the cast part is smaller than in a direction which is perpendicular both to the thickness direction and to the longitudinal direction of the cooling channel.

As a result, the areas surrounding the cooling channel in the thickness direction are increased in comparison with a circular cooling channel. At the same time, the wall thickness of the cast part in regions radially adjacent to the cooling channel is increased, which increases the stability.

Finally, the invention includes the use of a cooling channel produced by roll welding in a cast part.

### BRIEF DESCRIPTION OF THE DRAWINGS

Below the invention is explained in more detail with reference to a preferred exemplary embodiment with reference to the accompanying drawings.

FIGS. 1 and 2 show schematically individual steps of a preferred exemplary embodiment of the production method according to the invention,

FIG. 3 shows a stack of sheets, which is the result of the production step of FIG. 2(c),

FIG. 4 shows a schematic sectional view of a casting apparatus used in the described exemplary embodiment of the manufacturing method, and

FIG. 5 shows schematically a cross-sectional view of a cast part according to the invention.

### DETAILED DESCRIPTION

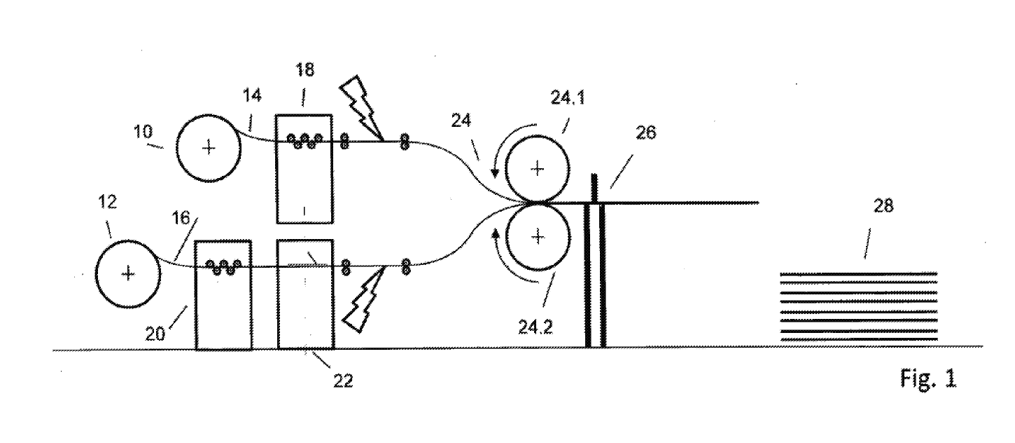

FIG. 1 shows two coils 10, 12 of sheets 14 and 16, respectively. The sheets 14, 16 are made of light metal, such as aluminum, or an aluminum alloy. After unwinding from the coils 10, 12 the sheets 14, 16 pass through roller levelers 18 and 20. After the roller leveler 20, the sheet 16 passes a station 22 for applying a release agent. In this case, the release agent is applied in the form of a pattern that corresponds to the cooling channel to be formed later.

The sheet 14 is heated after passing through the roller leveler 18. The same applies to the sheet 16 after passing the station 22. The heated sheets 14, 16 are then fed together to a roll welding device 24 with two welding rollers 24.1 and 24.2, where the sheets are welded together by roll welding. Welding takes place only in regions that are not provided with release agent. This is followed by cutting to length in a cutting device 26. The length-cut roll-welded stacks of sheets are then stacked into a stack 28. The welding rollers 24.1 and 24.2 are profiled, so that the rolling roughens the surfaces of the sheets 14, 16.

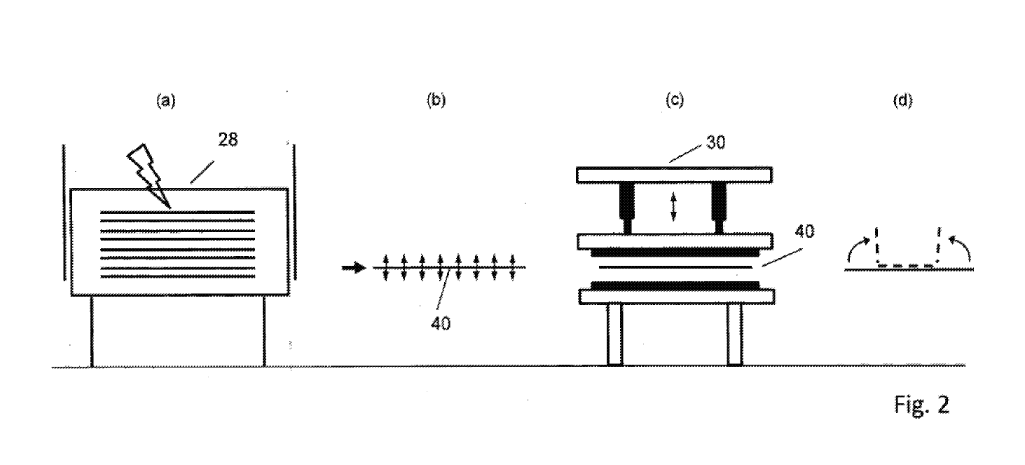

As can be seen from FIG. 2(a), the stack 28 is annealed. Thereafter, as shown in FIG. 2(b), inflation takes place. In this case, compressed air is blown between the two sheets of stacks of sheets, specifically where they are not welded together because of the release agent. Instead of compressed air, other pressurizing media can be used. As a result of the inflation, the two sheets move away from one another in the region provided with the release agent, so that a cavity is formed between them. This cavity is formed according to the same pattern as that of release agent applied to the sheet 16 and thus forms a channel.

Although not shown in FIG. 2(b), an abutment-forming molding tool may be disposed on one or both sides of the channel to be formed during inflation, which molding tool provides a design for the channel forming by the inflation. This is in particular a design that deviates from the circular cross-sectional area.

Moreover, by suitable application and design of one or more molding tools it can also be achieved that the cross-section of the channel forming by inflation over its length is not constant, but rather, for example, steadily increasing or decreasing. As a result, a fine adjustment of the cooling capacity of the channel to be produced can be achieved.

FIG. 2(c) shows a punch by means of which the stack of sheets inflated in the station according to FIG. 2(b) is punched out.

The punched stack of sheets is then formed into a groove as shown in FIG. 2(d).

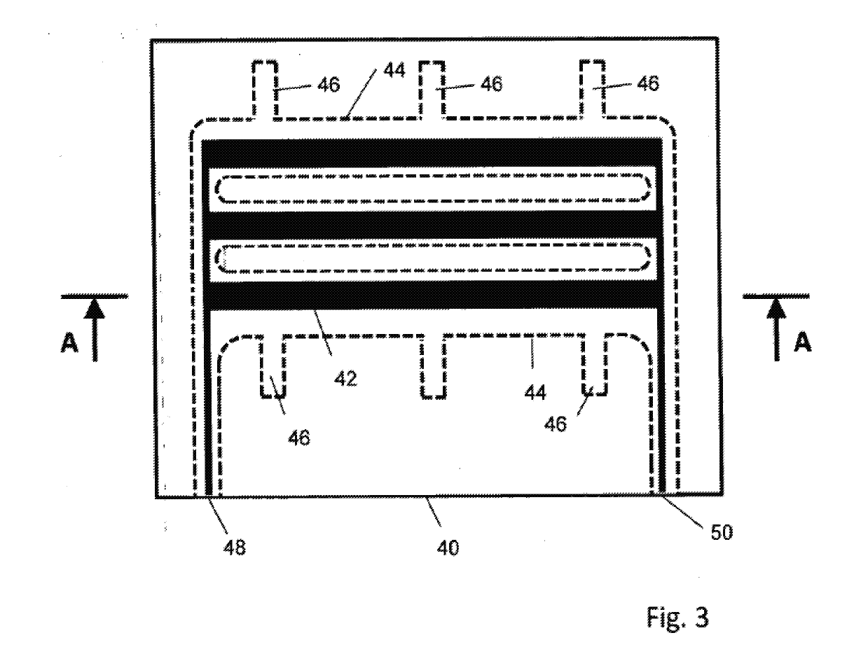

FIG. 3 shows a stack of sheets 40 composed of two sheets, as it is supplied to the punch 30 according to FIG. 2(c) after the inflation according to FIG. 2(b). An inflated region formed in the form of a branched channel 42 can be seen. The channel 42 is an exemplary embodiment of the cooling channel according to the invention.

The dashed line 44 in FIG. 3 indicates the punching contour along which the stack of sheets 40 is punched in the punch 30. The punching leads to positioning aids or core locations 46.

In FIG. 3, a coolant inlet is designated by the reference numeral 48, a coolant outlet is designated with the reference numeral 50.

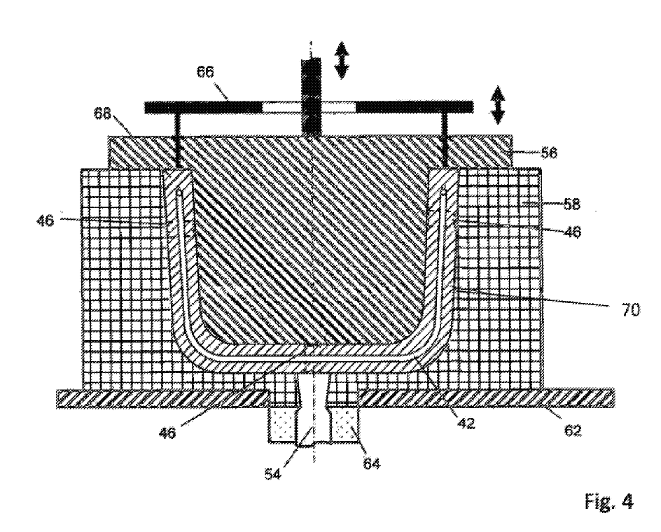

FIG. 4 shows the stack of sheets 40 in a casting device, with which a low-pressure chill casting for producing a cast part 70 in the form of a battery tray with the cooling channel 42 takes place. A sprue 54, an upper core 56, a lower core, a machine plate 62, an insulating insert 64 and an ejector plate 66 with ejectors can be seen. The low-pressure chill casting takes place with the described casting device as follows:

First, the stack of sheets 40 with the cooling channel 42 is inserted. Then the top core 56 is applied. Thereafter, the pressure build-up or the casting takes place, wherein light metal 68 such as aluminum or an aluminum alloy is introduced through the sprue 54. Meanwhile, the cooling channel 42 is cooled. The light metal 68 has a lower melting range than the sheets 14, 16.

After solidification of the light metal 68, the pressure is released, and the top core 56 is raised with the finished cast part. Then the ejector of the ejector plate 66 are extended and the finished cast part is removed.

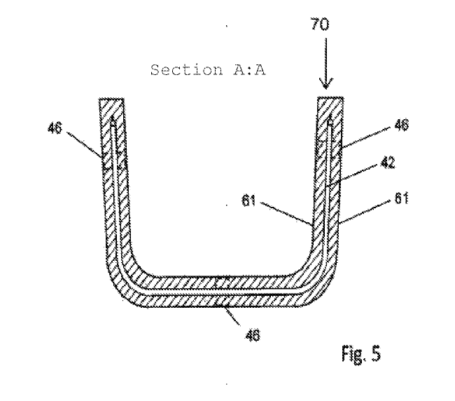

FIG. 5 shows a cross-sectional view of the cast part 70 shown in the method described above, which is a battery tray in the illustrated exemplary embodiment. The cooling channel 42 is elongated in the illustration of FIG. 4 and extends in the middle between the two wall surfaces 60 and 61.

The cast part according to the invention can be not only a battery tray, but also other components requiring cooling, such as a housing of an electric motor stator or a battery housing or a housing for components of the power electronics. The main focus is here on components for mobile applications, for example in vehicles, especially land vehicles.

The features of the invention disclosed in the above description, the claims and the drawings may be essential both individually and in any combination for the realization of the invention in its various embodiments.

1. A method for producing a cast metal part, in particular a housing of an electric motor stator, a housing for components of power electronics, a battery tray or a battery housing, having the following steps:
producing a cooling channel,
introducing the cooling channel into a casting tool,
filling the casting tool with a casting material, and molding the cast part,
characterized in that
said producing of the cooling channel includes a roll welding step.

2. The method according to claim 1, characterized in that said producing of said cooling channel includes the steps of:
a) providing two sheets,
b) applying a release agent in at least a region of the sheets,
c) heating the sheets,
d) roll welding the sheets; and
e) applying pressure such that a channel is formed in the region provided with the release agent,
wherein steps b) and c) can also be performed simultaneously or in reverse order.

3. The method according to claim 2, characterized in that upon applying pressure to form the channel at least one abutment is arranged such that the outer skin of the channel abuts against it and so assumes a profile corresponding to the abutment.

4. The method according to claim 2, characterized by the step of punching.

5. The method according to claim 4, characterized in that during punching at least one core bearing and/or at least one spacer and/or at least one fastening tab is/are formed.

6. The method according to claim 1, characterized in that the cooling channel is brought into a predetermined shape, in particular in the shape of a groove, prior to introduction or during introduction into the casting tool.

7. The method according to claim 1, characterized in that the filling of the casting tool takes place in the manner of chill casting or sand casting.

8. The method according to claim 1, characterized in that at least one of the sheets and/or the casting material contain(s) a light metal or a light metal alloy.

9. The method according to claim 1, characterized in that the melting range of the sheets is higher than that of the casting material.

10. The method according to claim 1, characterized in that the cooling channel is cooled before and/or during the filling of the casting tool.

11. The method according to claim 1, characterized in that the outer surface of the cooling channel is coated.

12. The method according to claim 1, characterized in that the casting tool is subjected to ultrasound during the casting process.

13. The method according to claim 1, characterized by a heat treatment of the cooling channel.

14. The method according to claim 1, characterized in that at least one surface of at least one of the sheets is roughened prior to filling the casting tool, in particular by using a profiled roll during roll welding or by blasting the sheet(s).

15. The method according to claim 1, characterized in that the cooling channel is pressurized internally during the casting process.

16. A cast part with a cooling channel, characterized in that it is produced by a method according to claim 1.

17. The cast part according to claim 16, characterized in that the cooling channel has an inner cross-section which increases at least in sections over its length.

18. The cast part according to claim 16, characterized in that the cooling channel has an inner cross-section deviating at least in sections from the circular shape.

19. The cast part according to claim 16, characterized in that at least in sections, the inner dimension of the cooling channel in the thickness direction of the cast part is smaller than in a direction which is perpendicular both to the thickness direction and to the longitudinal direction of the cooling channel,

20. A cooling channel produced according to claim 1, and further produced by roll welding in a cast part, in particular in a housing of an electric motor stator, a housing for electronic components, a battery tray or a battery housing.
